(19) United States
(12) Patent Application Publication
(10) Pub. No.: US 2020/0282413 A1
(43) Pub. Date: Sep. 10, 2020

(54) ATOMIZATION NOZZLE AND ATOMIZATION DEVICE

(71) Applicant: Puzhen Life Co., Ltd., Hong Kong (HK)

(72) Inventor: Andy LEE, Hong Kong (HK)

(21) Appl. No.: 16/536,374

(22) Filed: Aug. 9, 2019

Related U.S. Application Data
(63) Continuation of application No. PCT/CN2019/077562, filed on Mar. 8, 2019.

(30) Foreign Application Priority Data
Mar. 8, 2019 (CN) 2019203003279

(51) Int. Cl. B05B 7/04

(52) U.S. Cl. CPC B05B 7/0483

(57) ABSTRACT

The present application provides an atomization device and the atomization device. The atomization device (20) includes a nozzle body (201), the nozzle body (20) including a gas inlet channel (21), an atomization channel (22), and a liquid inlet channel (23). One end of the gas inlet channel (21) defines a gas inlet (211), and the other end of the gas inlet channel (21) defines a gas ejecting port (212) intercommunicating with the atomization channel (22). One end of the liquid inlet channel (23) defines a liquid inlet (231), and the other end of the liquid inlet channel (23) defines a liquid ejecting port (232) intercommunicating with the atomization channel (22). An inner diameter of the atomization channel (22) approaching the liquid ejecting port (232) is greater than an inner diameter of the gas ejecting port (212) to enable an intake gas flow from the gas inlet channel (21) to form a negative pressure region at such site and to facilitate mixing of the liquid and gas to form an aerosol. The atomization channel (22) defines an aerosol generating port (221) configured to eject the aerosol. The atomization nozzle and the atomization device provided by the present application can effectively improve the atomization efficiency, and solve the problem that the prior art split type atomization nozzle has excessive volume and inconsistent atomization efficiency.

### TECHNICAL FIELDS

The present application relates to the technical field of nozzles, and more particularly to an atomization nozzle and an atomization device.

### BACKGROUND

At present, the atomization nozzles on the market are all split type and need to be assembled into an integral. However, the atomization nozzle has relatively large volume and low assembling accuracy, which would result in inconsistence in the atomization nozzle and low atomization efficiency.

### TECHNICAL PROBLEM

It is an object of the present application to provide an atomization nozzle and an atomization device to solve the technical problem of low atomization efficiency in the atomization nozzle of the prior art.

### TECHNICAL SOUTIONS

In order to achieve the above objects, the present application adopts the following technical solutions: an atomization nozzle is provided. The atomization nozzle comprises a nozzle body, with the nozzle body comprising: a gas inlet channel, an atomization channel, and a liquid inlet channel. One end of the gas inlet channel defines a gas inlet, and the other end of the gas inlet channel defines a gas ejecting port intercommunicating with the atomization channel. One end of the liquid inlet channel defines a liquid inlet, and the other end of the liquid inlet channel defines a liquid ejecting port intercommunicating with the atomization channel. An inner diameter of the atomization channel approaching the liquid ejecting port is greater than an inner diameter of the gas ejecting port to enable an intake gas flow from the gas inlet channel to form a negative pressure region at such site and to facilitate mixing of the liquid and gas to form an aerosol. The atomization channel defines an aerosol generating port configured to eject the aerosol.

Further, a step is formed between the gas ejecting port and the liquid ejecting port and configured to prevent a gas flow ejected from the gas ejecting port from directly impacting into the liquid ejecting port and thereby preventing the gas from entering the liquid inlet channel.

Further, the inner diameter of the atomization channel is defined as D2, and the atomization channel 22 is a channel with an equivalent inner diameter;

Further, an inner diameter of the liquid ejecting port is defined as D3, a distance from one end of the step contacting the gas ejecting port to the center of the liquid ejecting port is defined as L, and the following relationship among D2, D3, and L is to be satisfied:

D2≥D3, and 1/2D3≤L≤D2.

Further, an inner diameter of the gas inlet channel gradually reduces in a direction from the gas inlet towards the gas ejecting port.

Further, an inner diameter of the liquid inlet channel gradually reduces in a direction from the liquid inlet towards the liquid ejecting port.

Further, the aerosol generating port is trumpet-shaped, an inner diameter of the aerosol generating port gradually increases in a direction away from the atomization channel. The gas inlet channel and the atomization channel are coaxially arranged, one end of the liquid inlet channel contacting the liquid ejecting port is arranged to be perpendicular to the atomization channel or at an acute angle with respect to the atomization channel.

The present application further provides an atomization device, which comprises the atomization nozzle as described in the above.

Further, the atomization device comprises: a casing, and a mounting frame arranged within the casing. The mounting frame is provided with a liquid storing bottle and a gas pump, and the mounting frame defines an atomization chamber and a gas flow channel in communication with the atomization chamber and configured to allow the gas generated from the gas pump to enter the atomization nozzle. The atomization nozzle is installed inside the gas flow channel, the liquid inlet channel of the atomization nozzle is in communication with the liquid storing bottle, and the aerosol generating port of the atomization nozzle is in communication with the atomization chamber. One end of the casing away from the liquid storing bottle defines an aerosol outlet, and the aerosol outlet is in communication with the atomization chamber.

Further, the mounting frame comprises: a mounting seat, a nozzle support connected and fixed to the mounting seat, and a gas pump support connected and fixed to the nozzle support. The mounting seat is in abut connection with the nozzle support to form the atomization chamber; the liquid storing bottle is installed within the mounting seat, the gas flow channel is arranged at the nozzle support, and the gas pump is installed at the gas pump support.

Further, two ends of the gas flow channel have a first gas guiding hole in communication with the gas pump and a second gas guiding hole in communication with the first gas guiding hole, respectively. A center axis of the first gas guiding hole and a center axis of the second gas guiding hole are coaxially arranged or staggered from each other. The atomization nozzle is installed at the second gas guiding hole.

Further, the mounting seat is provided with an accommodation chamber; the liquid storing bottle is detachably installed inside the accommodation chamber, and the bottle mouth of the liquid storing bottle is configured to be arranged at one end of the liquid storing bottle facing towards the atomization chamber.

Further, the atomization nozzle is installed above the bottle mouth of the liquid storing bottle, and the aerosol generating port of the atomization nozzle is disposed above the bottle mouth and faces towards the bottle mouth;

or alternatively, the atomization nozzle extends into the bottle mouth of the liquid storing bottle, the aerosol generating port of the atomization nozzle is disposed within the bottle mouth, and the atomization chamber is in communication with the bottle mouth.

### BENEFICIAL EFFECT

The atomization nozzle and the atomization device provided by the present application have the following beneficial effects:

when compared with the prior art, the atomization nozzle provided by the present application comprises the nozzle body, which comprises: the gas inlet channel, the atomization channel, and the liquid inlet channel. One end of the gas inlet channel defines the gas inlet, the other end of the gas inlet channel defines the gas ejecting port, and the gas ejecting port and the atomization channel intercommunicate with each other. One end of the liquid inlet channel defines the liquid inlet, the other end of the liquid inlet channel defines the liquid ejecting port, and the liquid ejecting port and the atomization channel intercommunicate with each other. Gas generated from the gas pump is taken in via the gas inlet and pass through the gas ejecting port such that a high velocity gas flow is ejected and enters the atomization channel. Because the inner diameter of the liquid ejecting port approaching the atomization channel is greater than the inner diameter of the gas ejecting port, the intake gas flow of the gas inlet channel forms the negative pressure region at such site, such that the liquid from the liquid storing bottle passes through the liquid inlet to enter the liquid inlet channel and then be ejected via the liquid ejecting port. Under the impact of the high velocity gas flow, the liquid ejected from the liquid ejecting port forms fine aerosol droplets, which is ejected from the aerosol generating port. The sealing performance is good, the utilization efficiency of the gas flow is relatively high, and even in the case of low speed, a sufficient negative pressure can be formed to enable the liquid to be drawn into the atomization channel, thereby effectively improving the atomization efficiency, and solving the problem that the splitting type atomization nozzle in the prior art is oversized and inconsistent in atomization efficiency.

### DESCRIPTION OF THE DRAWINGS

In order to more clearly illustrate the technical solutions in the embodiments of the present application, the drawings used in the embodiments or the prior art description will be briefly described hereinbelow. Obviously, the drawings in the following description are only some embodiments of the present application. Other drawings may be obtained from those skilled in the art without departing from the scope of the application.

FIG. 1 is a first perspective structural view of an atomization nozzle provided by an embodiment of the present application;

FIG. 2 is a second perspective structural view of an atomization nozzle provided by an embodiment of the present application;

FIG. 3 is a top structural view of an atomization nozzle provided by an embodiment of the present application;

FIG. 4 is a cross-sectional structural view taken from line A-A of FIG. 3;

FIG. 5 is an enlarged structural view of part B of FIG. 4;

FIG. 6 is perspective structural view of an atomization nozzle provided by an embodiment of the present application;

FIG. 7 is top structural view of an atomization nozzle provided by an embodiment of the present application;

FIG. 8 is a cross-sectional structural view taken from line C-C of FIG. 7;

FIG. 9 is an exploded structural view of an atomization device provided by an embodiment of the present application;

FIG. 10 is an exploded structural view of an atomization assembly provided by an embodiment of the present application;

FIG. 11 is a first perspective structural view of a mounting seat provided by an embodiment of the present application;

FIG. 12 is a second perspective structural view of a mounting seat provided by an embodiment of the present application;

FIG. 13 is a top structural view of a mounting seat provided by an embodiment of the present application;

FIG. 14 is a cross-sectional view taken from line D-D of FIG. 13;

FIG. 15 is a first perspective structural view of a nozzle support provided by an embodiment of the present application;

FIG. 16 is a second perspective structural view of a nozzle support provided by an embodiment of the present application;

FIG. 17 is a top structural view of a nozzle support provided by an embodiment of the present application; and

FIG. 18 is a cross-sectional view taken from line E-E of FIG. 17.

In the drawings, reference numerals are as follows:

100: Casing; 110: Inner cavity; 120: Aerosol outlet; 130: Upper casing; 140: Lower casing; 300: Mounting frame; 310: Atomization chamber; 10: Liquid storing bottle; 11: Bottle mouth; 111:Third seal member; 20: Atomization nozzle; 201: Nozzle body; 21: Gas inlet channel; 211: Gas inlet; 212: Gas ejecting port; 22: Atomization channel; 221: Aerosol generating port; 23: Liquid inlet channel; 231: Liquid inlet; 232: Liquid ejecting port; 24: Step; 30;Gas pump; 40: Mounting seat; 401: First through hole; 402: Accommodation chamber; 403: Second seal member; 404: Positioning column; 41: First locking member First; 42: Second locking member; 43: Flange; 44: Accommodation space; 50: Nozzle support; 501: Second through hole; 511: Gas flow channel; 511: First gas guiding hole; 512: Second gas guiding hole; 513: First seal member; 514: Check valve; 52: Aerosol discharge channel; 53: Pipette; 60: Gas pump bracket; 601: Third through hole; and 70: Power supply device.

### DESCRIPTION OF THE EMBODIMENTS

In order to make the purposes, technical solutions, and advantages of the present application clearer and more understandable, the present application will be further described in detail hereinafter with reference to the accompanying drawings and embodiments. It should be understood that the embodiments described herein are only intended to illustrate but not to limit the present application.

It should be noted that when an element is described as “fixed” or “arranged” on/at another element, it means that the element can be directly or indirectly fixed or arranged on/at another element. When an element is described as “connected” to/with another element, it means that the element can be directly or indirectly connected to/with another element.

It should be understood that terms “length”, “width”, “upper”, “lower”, “front”, “rear”, “left”, “right”, “vertical”, “horizontal”, “top”, “bottom”, “inside”, “outside” and the like indicating orientation or positional relationship are based on the orientation or the positional relationship shown in the drawings, and are merely for facilitating and simplifying the description of the present application, rather than indicating or implying that a device or component must have a particular orientation, or be configured or operated in a particular orientation, and thus should not be construed as limiting the application.

Moreover, the terms “first” and “second” are adopted for descriptive purposes only and are not to be construed as indicating or implying a relative importance or implicitly indicating the number of technical features indicated. Thus, features prefixed by “first” and “second” will explicitly or implicitly represent that one or more of the referred technical features are included. In the description of the present application, the meaning of “a plurality of” or “multiple” is two or more unless otherwise specifically defined.

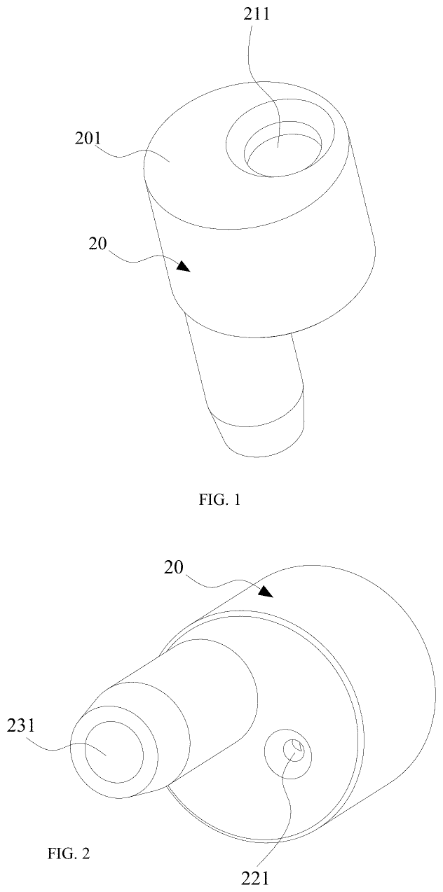

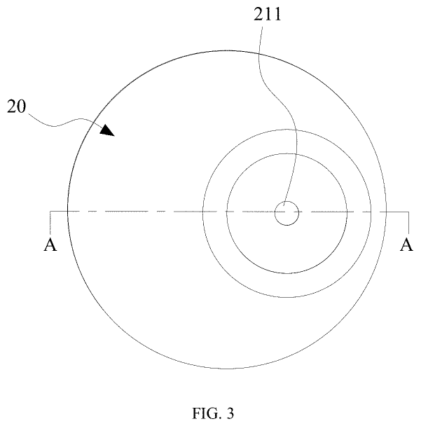

Referring to FIGS. 1-5, an atomization nozzle 20 provided by the present application is illustrated. The atomization nozzle 20 may be applied to household atomization devices, such as atomization of essential oil or humidifiers. The atomization nozzle 20 comprises a nozzle body 201. The nozzle body 201 comprises: a gas inlet channel 21, an atomization channel 22, and a liquid inlet channel 23. The gas inlet channel 21 defines a gas inlet 211 at one end and a gas ejecting port 212 at the other end, and the gas ejecting port 212 and the atomization channel 22 intercommunicate with each other. The gas inlet 211 is configured to be connected with a gas pump in order to transport the gas generated from the gas pump to the atomization channel 22. The liquid inlet channel 23 defines a liquid inlet 231 at one end and a liquid ejecting port 232 at the other end, and the liquid ejecting port 232 and the atomization channel 22 intercommunicate with each other. The liquid inlet 231 is configured to be connected to a liquid storing bottle storing a liquid, for example, a liquid storing bottle storing an essential oil. An inner diameter of the atomization channel 22 approaching the liquid ejecting port 232 is greater than an inner diameter of the gas ejecting port 212, that is, when the inner diameter of the gas ejecting port 210 is D1 and the inner diameter of the atomization channel 22 is D2, then D2>D1. By designing the inner diameter of the atomization channel 22 approaching the liquid ejecting port 232 to be greater than the inner diameter of the gas ejecting port 212, such that an intake gas flow of the gas inlet channel 21 forms a negative pressure region at such site, which facilitates the mixing of the liquid and gas to form the aerosol. The atomization channel 22 defines an aerosol generating port 221 configured to eject the aerosol.

The atomization nozzle 20 provided by the present application, when compared with the prior art, comprises the nozzle body 201, which comprises: the gas inlet channel 21, the atomization channel 22, and the liquid inlet channel 23. One end of the gas inlet channel 21 defines the gas inlet 211, the other end of the gas inlet channel 21 defines the gas ejecting port 212, and the gas ejecting port 212 and the atomization channel 22 intercommunicate with each other. One end of the liquid inlet channel 23 defines the liquid inlet 231, the other end of the liquid inlet channel 23 defines the liquid ejecting port 232, and the liquid ejecting port 232 and the atomization channel 22 intercommunicate with each other. Gas generated from the gas pump is taken in via the gas inlet 211 and pass through the gas ejecting port 212 such that a high velocity gas flow is ejected and enters the atomization channel 22. Because the inner diameter of the liquid ejecting port 232 approaching the atomization channel 22 is greater than the inner diameter of the gas ejecting port 212, the intake gas flow of the gas inlet channel 21 forms the negative pressure region (Venturi effect) at such site, such that the liquid from the liquid storing bottle passes through the liquid inlet 231 to enter the liquid inlet channel 23 and then be ejected via the liquid ejecting port 232. Under the impact of the high velocity gas flow, the liquid ejected from the liquid ejecting port 232 forms fine aerosol droplets (Bernoulli's fluid mechanics), which are ejected from the aerosol generating port 221. The sealing performance is good, the utilization efficiency of the gas flow is relatively high, and even in the case of low speed, a sufficient negative pressure can be formed to enable the liquid to be drawn into the atomization channel 22, thereby effectively improving the atomization efficiency, and solving the problem that the splitting type atomization nozzle 20 in the prior art is oversized and inconsistent in atomization efficiency.

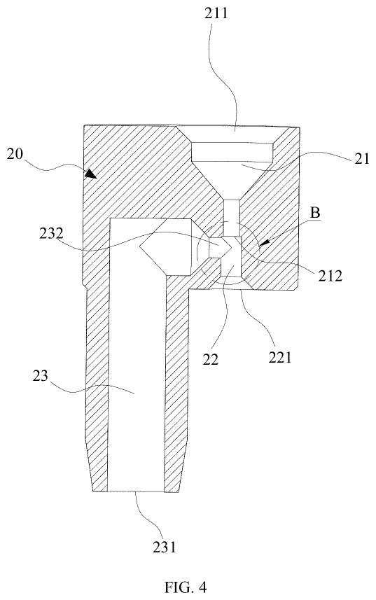

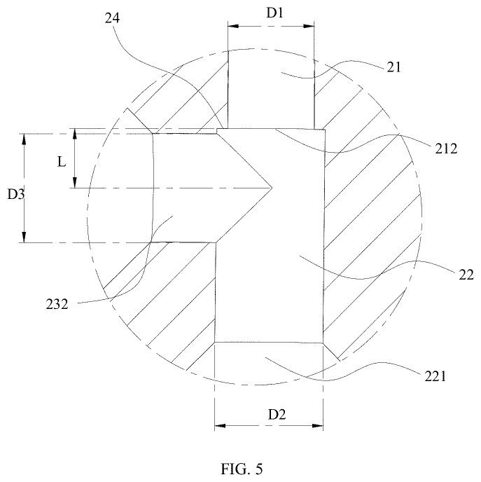

Further, as shown in FIGS. 4-5, as a specific embodiment of the atomization nozzle provided by the present application, a step 24 as illustrated in FIG. 5 is formed between the gas ejecting port 212 and the liquid ejecting port 232. The step 24 can effectively prevent the high velocity gas flow ejected from the gas ejecting port 212 from directly impacting into the liquid ejecting port 232, which would otherwise make the gas flow back to the external liquid storing bottle and make the liquid storing bottle to bubble.

Further, as shown in FIGS. 4-5, as a specific embodiment of the atomization nozzle 20 provided by the present application, the inner diameter of the atomization channel 22 is defined as D2, and the atomization channel 22 is a channel with an equivalent inner diameter, that is, the inner diameter of the atomization channel 22 is equivalent at any positions. An inner diameter of the liquid ejecting port 232 is defined as D3, a distance from one end of the step 24 contacting the gas ejecting port 212 to the center of the liquid ejecting port 232 is defined as L, and the following relationship among D2, D3, and L is to be satisfied: D2≥D3, and 1/2D3≤L≤D2. Due that D2≥D3 and 1/2D3≤L≤D2, the atomization efficiency can be greatly improved.

Further, as shown in FIGS. 4-5, as a specific embodiment of the atomization nozzle 20 provided by the present application, an inner diameter of the gas inlet channel 21 gradually reduces in a direction from the gas inlet 211 towards the gas ejecting port 212, such that the gas entering the gas inlet 211 is pressurized and therefore ejected out of the gas ejecting port 212 at a high velocity.

Further, as shown in FIGS. 4-5, as a specific embodiment of the atomization nozzle 20 provided by the present application, an inner diameter of the liquid inlet channel 23 gradually reduces in a direction from the liquid inlet 231 towards the liquid ejecting port 232, such that the pressure for drawing the liquid is improved, and the flow velocity is increased, thereby improving the atomization efficiency.

Further, as shown in FIGS. 4-5, as a specific embodiment of the atomization nozzle 20 provided by the present application, the aerosol generating port 221 is trumpet-shaped, an inner diameter of the aerosol generating port 221 gradually increases in a direction away from the atomization channel 22, thereby improving the ejection efficiency of the atomized droplets.

Further, as shown in FIGS. 4-5, as a specific embodiment of the atomization nozzle 20 provided by the present application, the gas inlet channel 21 and the atomization channel 22 are coaxially arranged, one end of the liquid inlet channel 21 contacting the liquid ejecting port 232 is arranged to be perpendicular to the atomization channel 22 or at an acute angle with respect to the atomization channel 22. Specifically, the atomization channel 22is arranged at a bottom of the gas inlet channel 21 (facing downwards), which makes the gas flow within the atomization channel 22 is guided downwards, thereby effectively solving refluxing difficulty in the atomization nozzle 20 in the prior art.

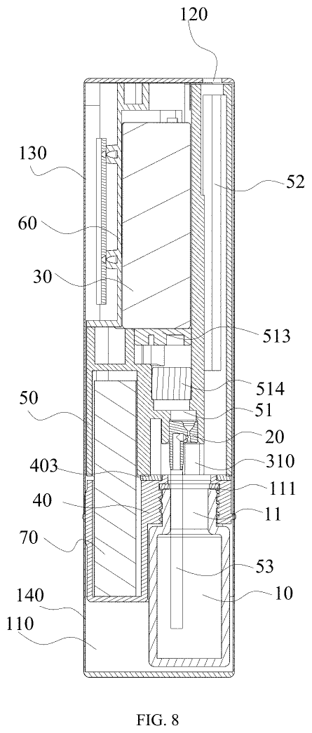

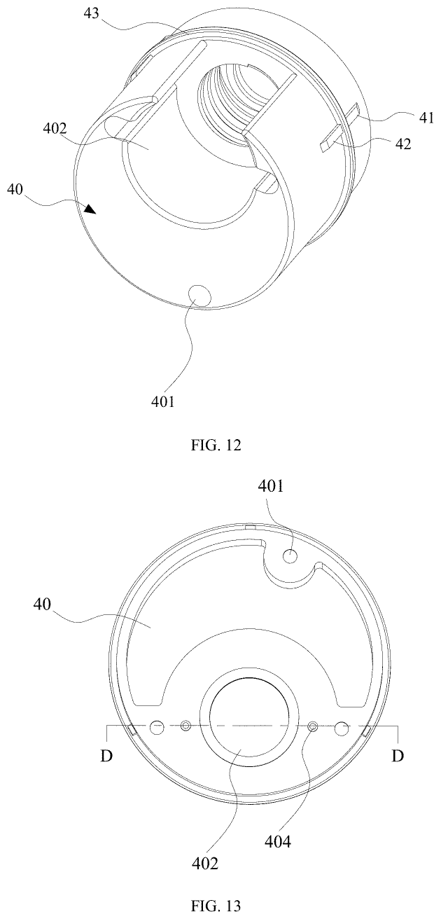

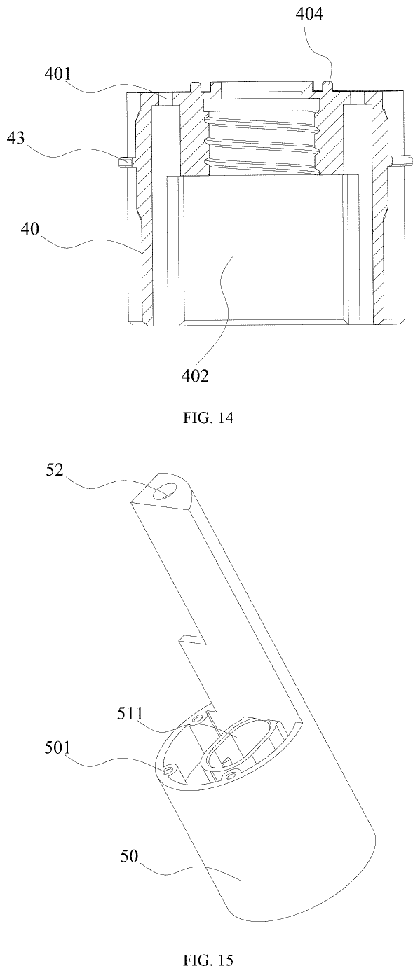

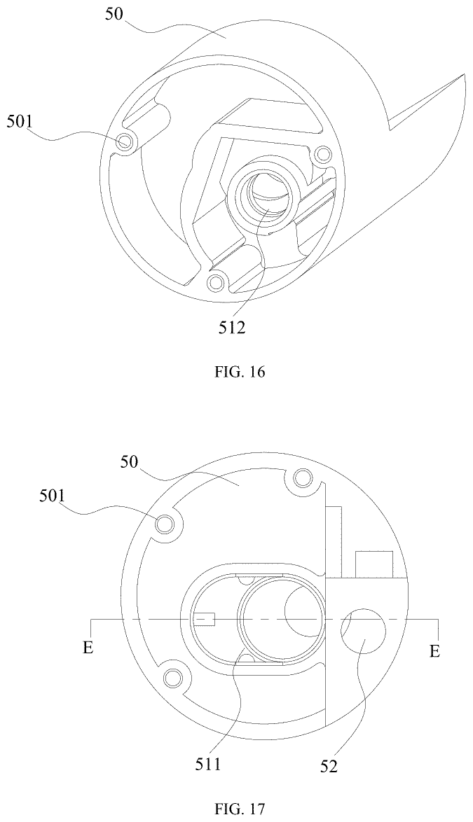

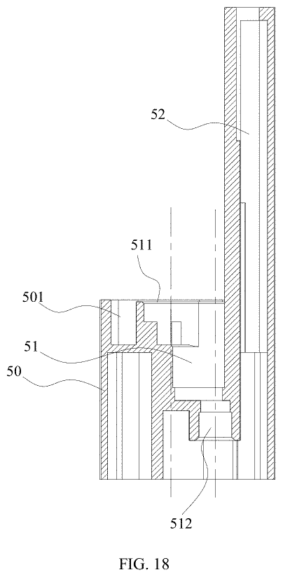

Referring to FIGS. 6-18, the present application further provides an atomization device. The atomization device may be an aromatherapy device or a humidifier. The atomization device comprises the above-described atomization nozzle 20. Further, The atomization device comprises a casing 100 and a mounting frame 300 arranged within the casing 100. The mounting frame 300 is provided with a liquid storing bottle 10 and a gas pump 30, and the mounting frame 300 defines an atomization chamber 310 and a gas flow channel 51 in communication with the atomization chamber 310 and configured to allow the gas generated from the gas pump 30 to enter the atomization nozzle 20. The atomization nozzle 20 is installed inside the gas flow channel 51, the liquid inlet channel 23 of the atomization nozzle 20 is in communication with the liquid storing bottle 10, and the aerosol generating port 221 of the atomization nozzle 20 is in communication with the atomization chamber 310. One end of the casing 10 away from the liquid storing bottle 10 defines an aerosol outlet 120, and the aerosol outlet 120 is in communication with the atomization chamber 310. Specifically, as shown in FIG. 8, the casing 100 has an inner cavity 110 in which the mounting frame 300 is installed.

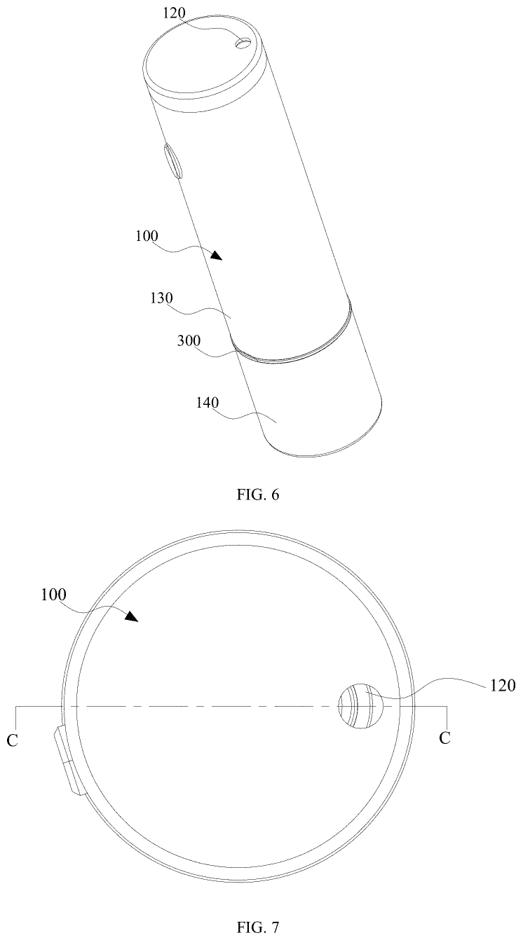

Further, referring to FIGS. 7-8, as a specific embodiment of the atomization device provided by the present application, the aerosol generating port 221 faces the bottle mouth 11 and is opposite the aerosol outlet 120, in this way, the distance between the atomization nozzle 20 and the aerosol outlet 120 is stretched, the gas pressure produced by the atomization nozzle 20 faces downwards, which enables the relatively large atomized droplets to directly and quickly flow back to the liquid storing bottle 10 via the open bottle mouth 11 while enabling the relatively small atomized droplets to raise and be ejected out via the aerosol outlet 120, such that the length of the atomization turbulence is much longer, secondary atomization is prone to be formed, thereby improving the atomization efficiency.

Further, referring to FIGS. 8-10, the atomization nozzle 20 is installed above the bottle mouth of the liquid storing bottle 10, and the aerosol generating port 221 of the atomization nozzle 20 is disposed above the bottle mouth 11 and faces towards the bottle mouth 11. The direction of the gas flow within the atomization chamber faces downwards, which can effectively solve the refluxing of the atomization nozzle in the prior art. Specifically, the liquid inlet of the atomization nozzle 20 may be in connection with the liquid storing bottle 10 via a pipette 53. In another preferred embodiment of the present application, the atomization nozzle 20 extends into the bottle mouth 11 of the liquid storing bottle 10, the aerosol generating port 221 of the atomization nozzle 20 is disposed within the bottle mouth 11, and the atomization chamber 310 is in communication with the bottle mouth 11. Because the aerosol generating port 221 is disposed within the bottle mouth 11, the gas pressure produced by the atomization nozzle 20 enables the relatively large atomized droplets to directly and quickly flow back to the liquid storing bottle 10 while enabling the relatively small atomized droplets to raise and escape from the open bottle mouth 11 and then be ejected out via the aerosol outlet 120, such that the length of the atomization turbulence is much longer, secondary atomization is prone to be formed, thereby improving the atomization efficiency.

Further, referring to FIGS. 8-10, the mounting frame comprises: a mounting seat 40, a nozzle support 50 connected and fixed to the mounting seat 40, and a gas pump support 60 connected and fixed to the nozzle support 50. The mounting seat 40 is in abut connection with the nozzle support 50 to form the atomization chamber 310. The liquid storing bottle 10 is installed within the mounting seat 40, the gas flow channel 51 is arranged at the nozzle support 50, and the gas pump 30 is installed at the gas pump support 60. By connecting the mounting seat 40, the nozzle support 50, the gas pump support 60 as a whole, the installation process can be simplified, and the installation efficiency is therefore improved.

Further, referring to FIGS. 8-10, as a specific embodiment of the atomization device provided by the present application, the atomization device further comprises a fastener (not shown) configured to connect and fix the mounting seat 40, the nozzle support 50, and the gas pump support 60. The mounting seat 40 defines therein a first through hole 401, the nozzle support 50 defines therein a second through hole 501, and the gas pump support 60 defines therein a third through hole 601. The fastener may be a blot, which passes through the first through hole 401, the second through hole 501, and the third through hole 601, respectively, and achieve the connection and fixation with a screw, which further achieves the connection and fixation of the mounting seat 40, the nozzle support 50, and the gas pump support 60.

Further, referring to FIGS. 15-18, as a specific embodiment of the atomization device provided by the present application, two ends of the gas flow channel 51 have a first gas guiding hole 511 in communication with the gas pump 30 and a second gas guiding hole 512 in communication with the first gas guiding hole 511. Specifically, a top end of the gas flow channel 51 is provided with a first gas guiding hole 511, and a bottom end of the gas flow channel 51 is provided with the second gas guiding hole 512. A center axis of the first gas guiding hole 511 and a center axis of the second gas guiding hole 512 are coaxially arranged. In another preferred embodiment of the present application, the center axis of the first gas guiding hole 511 and the center axis of the second gas guiding hole 512 are staggered from each other, that is, the center of the first gas guiding hole 511 and the center of the second gas guiding hole 512 are not arranged along the same axis. The atomization nozzle 20 is installed at the second gas guiding hole 512, by staggering the center of the first gas guiding hole 511 and the center of the second gas guiding hole 512 from each other, the gas flow generated from the gas pump 30 is prevented from aligning the atomization nozzle 20, thereby effectively lowering the noise generated by the gas pump 30.

Further, referring to FIGS. 8-14, as a specific embodiment of the atomization device provided by the present application, the first gas guiding hole 511 is provided therein with a first seal member 513. By the arrangement of the first seal member 513, the gas pump 30 is prevented from gas leakage, which improves the gas utilization efficiency of the gas.

Further, referring to FIGS. 8-10, as a specific embodiment of the atomization device provided by the present application, a check valve 514 is installed inside the gas flow channel 51. The arrangement of the check valve 514 enables the gas from the gas pump 30 to enter the gas flow channel 51 in one direction and the same time prevents the gas pump 30 from being corroded due to the backflow of the liquid of the atomization nozzle 20 into the gas pump 30, which would otherwise result in reduction of the service life of the gas pump 30.

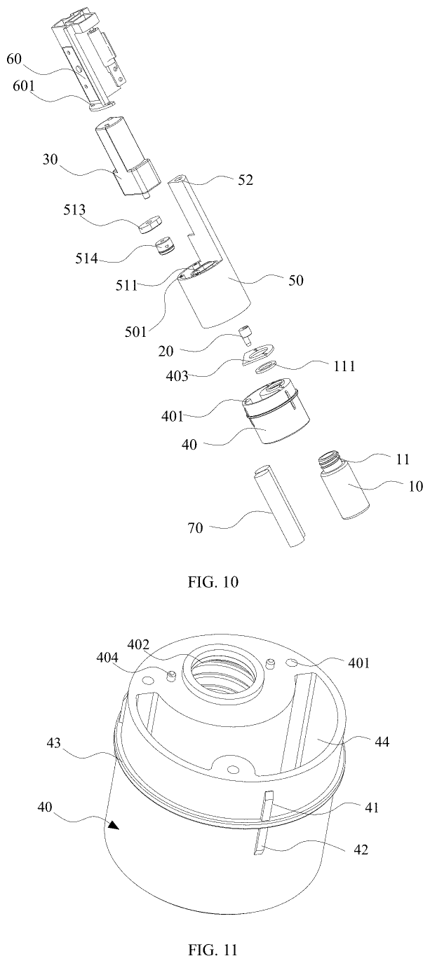

Further, referring to FIGS. 10, 15, and 18, as a specific embodiment of the atomization device provided by the present application, the nozzle support 50 is further provided with an aerosol discharge channel 52. A top of the aerosol discharge channel 52 corresponds to a position of the aerosol outlet 120 and is in communication with the aerosol outlet 120, and a bottom of the aerosol discharge channel 52 is in communication with the atomization chamber 310, therefore the aerosol discharged channel 52 is configured to guide the relatively small aerosol droplets in the atomization chamber 310 towards the aerosol outlet 120 where the aerosol droplets are ejected, thereby achieving the discharge of the aerosol.

Further, referring to FIGS. 8, 10, and 11, as a specific embodiment of the atomization device provided by the present application, the mounting seat 40 is provided with an accommodation chamber 402. The liquid storing bottle 10 is detachably installed inside the accommodation chamber 402, and the bottle mouth 11 is configured to be arranged at one end of the liquid storing bottle 10 facing towards the atomization chamber 310. Specifically, the bottle mouth 11 of the liquid storing bottle 10 is in an open state rather than a sealed state. Specifically, the liquid storing bottle 10 is detachably fixed within the accommodation chamber 402 via threaded connection or interference contact, which is convenient for replace the liquid storing bottle 10 timely, and the installation is very simple and convenient. It should be noted that the connection mode between the liquid storing bottle 10 and the mounting seat 40 is limited thereto. For example, in other preferred embodiment of the present application, the datable connection and fixation between the liquid storing bottle 10 and the mounting seat 40 can be realized by snap-fitting. Further, the connection site between the bottle mouth 11 and the accommodation chamber 402 is provided with a third seal member 111 as shown in FIG. 10, and the arrangement of the third seal member 111 can avoid liquid leakage.

Further, referring to FIGS. 8 and 10, as a specific embodiment of the atomization device provided by the present application, an abutting site between the mounting seat 40 and the nozzle support 50 is provided with a second seal member 403, which is configured to seal the atomization chamber 310, thereby preventing the connection site between the mounting seat 40 and the nozzle support 50 from cracking, and ensuring the tightness of the atomization chamber 310. Specifically, in the present embodiment, the second seal member 403 is provided with a positioning hole, and the mounting seat 40 is provided with a positioning column 404 which is configured to fit with the positioning hole. By the fitting positioning between the positioning column 404 and the positioning hole, the second seal member 403 can be accurately fixed at the mounting seat 40, which is convenient in the installation.

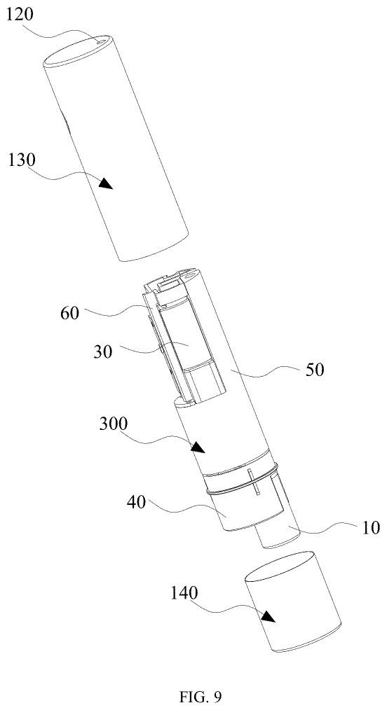

Further, referring to FIG. 9, as a specific embodiment of the atomization device provided by the present application, the casing 100 comprises an upper casing 130 and a lower casing 140, the upper casing 130 is detachably installed at a top end of the mounting frame, and the lower casing 140 is detachably installed at a bottom end of the mounting frame, thereby being capable of achieving the fast assemblage and dis-assemblage between the upper casing 130 and the lower casing 140.

Further, referring to FIGS. 8-12, as a specific embodiment of the atomization device provided by the present application, the upper casing 130 is detachably installed at the top end of the mounting seat 40, and the lower casing 140 is detachably installed at the bottom end of the mounting seat 40 (that is, the end of the mounting seat 40 away from the upper casing 130), such that the fast assemblage and dis-assemblage between the upper casing 130 and the lower casing 140 can be realized. It should be noted that the upper casing 130 may also be detachably installed at the top end of the nozzle support 50 and the lower casing 140 may be detachably installed at the bottom end of the nozzle support 50; or alternatively, the upper casing 130 may be detachably installed at the top end of the gas pump support 60, and the lower casing 140 may be detachably installed at the bottom end of the gas pump support 60, which can also realize the detachable connection between the upper casing 130 and the lower casing 140 likewise.

Further, referring to FIGS. 8-12, as a specific embodiment of the atomization device provided by the present application, an outer sidewall of the mounting seat 40 is provided with a first locking member 41 and a second locking member 42 shown in FIG. 11. The upper casing 130 is sleeved outside a top end of the mounting seat 40, and an inner sidewall of the upper casing 130 is in interference fit with the first locking member 41. The lower casing 140 is sleeved outside a bottom end of the mounting seat 40, and an inner sidewall of the lower casing 140 is in interference fit with the second locking member 42. In this way, the upper casing 130 can be detachably locked outside the mounting seat 40, while the lower casing 140 can be detachably locked outside the mounting seat 40. It should be noted that the upper casing 130 and the lower casing 140 can be connected at the mounting seat 40 in a manner of threaded connection, which can realize the detachable connection and fixation likewise.

Further, referring to FIGS. 8-12, as a specific embodiment of the atomization device provided by the present application, a periphery of the mounting seat 40 is convex to form a flange 43. A thickness of the first locking member 41 and a thickness of the second locking member 42 gradually increase in a direction approaching the flange 43. When it is required to install the upper casing 130, the upper casing 130 is sleeved in a direction towards the flange 43; when the upper casing 130 is installed at the mounting seat 40, the bottom edge of the upper casing 130 abuts against an upper edge of the flange 43, and the inner sidewall of the upper casing 130 is in interference fit with the first locking member 41. When it is required to install the lower casing 140, the lower casing 140 can be sleeved in a direction towards the flange 43, and when the lower casing 140 is installed at the mounting seat 40, in such condition, the top edge of the lower casing 140 abuts against the lower edge of the flange 43, and the inner sidewall of the lower casing 140 is in interference fit with the second locking member 42.

Further, referring to FIGS. 8-12, as a specific embodiment of the atomization device provided by the present application, the atomization device further comprises a circuit board (not shown in the figures) and a power supply device 70. The power supply device 70 can be a built-in power supply. The mounting seat 40 is provided therein with an accommodation space 44, and the built-in power supply can be installed inside the accommodation space 44. It should be noted that the arrangement of the power supply device 70 is not limited thereto, for example, in a preferred embodiment of the present application, the power supply device 70 may be an external power supply, or an interface configured for connecting an external power supply is provided at the same time of the arrangement of the built-in power supply, or charging a rechargeable battery via an external power supply connector.

The assembly process of the atomization device of the present application is as follows:

First, the liquid storing bottle 10 is mounted at the mounting seat 40, the atomization nozzle 20 is mounted at the nozzle support 50, and the gas pump 30 is mounted at the gas pump support 60;

Thereafter, the mounting seat 40, the nozzle support 50, the gas pump support 60 are connected and fixed, and a nozzle of the gas pump 30 is enabled to face the gas inlet 211 of the atomization nozzle 20, the aerosol generating port is located above the bottle mouth 11 of the liquid storing bottle 10; and

Finally, the upper casing 130 is snapped onto the mounting seat 40, and the lower casing 140 is snapped onto the mounting seat 40 and installed.

The above is only the preferred embodiments of the present application, and is not intended to limit the application. Any modifications, equivalent substitutions, and improvements made within the spirit and principles of the present application are included in the protection scope of the present application.

What is claimed is:

1. An atomization nozzle, comprising a nozzle body, with the nozzle body comprising: a gas inlet channel, an atomization channel, and a liquid inlet channel; wherein
one end of the gas inlet channel defines a gas inlet, and the other end of the gas inlet channel defines a gas ejecting port intercommunicating with the atomization channel;
one end of the liquid inlet channel defines a liquid inlet, and the other end of the liquid inlet channel defines a liquid ejecting port intercommunicating with the atomization channel;
an inner diameter of the atomization channel approaching the liquid ejecting port is greater than an inner diameter of the gas ejecting port to enable an intake gas flow from the gas inlet channel to form a negative pressure region at such site and to facilitate mixing of the liquid and gas to form an aerosol; and
the atomization channel defines an aerosol generating port configured to eject the aerosol.

2. The atomization nozzle of claim 1, wherein a step is formed between the gas ejecting port and the liquid ejecting port and configured to prevent a gas flow ejected from the gas ejecting port from directly impacting into the liquid ejecting port and thereby preventing the gas from entering the liquid inlet channel.

3. The atomization nozzle of claim 2, wherein
the inner diameter of the atomization channel is defined as D2, and the atomization channel 22 is a channel with an equivalent inner diameter;
an inner diameter of the liquid ejecting port is defined as D3, a distance from one end of the step contacting the gas ejecting port to the center of the liquid ejecting port is defined as L, and the following relationship among D2, D3, and L is to be satisfied:
D2≥D3, and 1/2D3≤L≤D2.

4. The atomization nozzle of claim 1, wherein an inner diameter of the gas inlet channel gradually reduces in a direction from the gas inlet towards the gas ejecting port.

5. The atomization nozzle of claim 1, wherein an inner diameter of the liquid inlet channel gradually reduces in a direction from the liquid inlet towards the liquid ejecting port.

6. The atomization nozzle of claim 1, wherein the aerosol generating port is trumpet-shaped, an inner diameter of the aerosol generating port gradually increases in a direction away from the atomization channel.

7. The atomization nozzle of claim 1, wherein the gas inlet channel and the atomization channel are coaxially arranged, one end of the liquid inlet channel contacting the liquid ejecting port is arranged to be perpendicular to the atomization channel or at an acute angle with respect to the atomization channel.

8. An atomization device, comprising the atomization nozzle of claim 1.

9. The atomization device of claim 8, comprising: a casing, and a mounting frame arranged within the casing; wherein
the mounting frame is provided with a liquid storing bottle and a gas pump, and the mounting frame defines an atomization chamber and a gas flow channel in communication with the atomization chamber and configured to allow the gas generated from the gas pump to enter the atomization nozzle;
the atomization nozzle is installed inside the gas flow channel, the liquid inlet channel of the atomization nozzle is in communication with the liquid storing bottle, and the aerosol generating port of the atomization nozzle is in communication with the atomization chamber; and
one end of the casing away from the liquid storing bottle defines an aerosol outlet, and the aerosol outlet is in communication with the atomization chamber.

10. The atomization device of claim 9, wherein
the mounting frame comprises: a mounting seat, a nozzle support connected and fixed to the mounting seat, and a gas pump support connected and fixed to the nozzle support;
the mounting seat is in abut connection with the nozzle support to form the atomization chamber; the liquid storing bottle is installed within the mounting seat, the gas flow channel is arranged at the nozzle support, and the gas pump is installed at the gas pump support.

11. The atomization device of claim 9, wherein
two ends of the gas flow channel have a first gas guiding hole in communication with the gas pump and a second gas guiding hole in communication with the first gas guiding hole, respectively;
a center axis of the first gas guiding hole and a center axis of the second gas guiding hole are coaxially arranged or staggered from each other; and
the atomization nozzle is installed at the second gas guiding hole.

12. The atomization device of claim 9, wherein the mounting seat is provided with an accommodation chamber; the liquid storing bottle is detachably installed inside the accommodation chamber, and the bottle mouth of the liquid storing bottle is configured to be arranged at one end of the liquid storing bottle facing towards the atomization chamber.

13. The atomization device of claim 9, wherein
the atomization nozzle is installed above the bottle mouth of the liquid storing bottle, and the aerosol generating port of the atomization nozzle is disposed above the bottle mouth and faces towards the bottle mouth;
or alternatively, the atomization nozzle extends into the bottle mouth of the liquid storing bottle, the aerosol generating port of the atomization nozzle is disposed within the bottle mouth, and the atomization chamber is in communication with the bottle mouth.
